(19) United States
(12) Patent Application Publication
(10) Pub. No.: US 2026/0333357 A1
(43) Pub. Date: Oct. 22, 2026

(54) Uplink Transmitter Switching with Multiple Supplementary Uplink Bands or Carriers

(71) Applicant: Apple Inc., Cupertino, CA (US)

(72) Inventors: Ankit BHAMRI, Haar (DE); Sigen YE, San Diego, CA (US); Wei ZENG, Saratoga, CA (US); Yang TANG, San Jose, CA (US); Dawei ZHANG, Saratoga, CA (US); Haitong SUN, Saratoga, CA (US); Hong HE, San Jose, CA (US); Oghenekome OTERI, San Diego, CA (US); Seyed Ali Akbar FAKOORIAN, San Diego, CA (US); Weidong YANG, San Diego, CA (US)

(21) Appl. No.: 19/101,460

(22) PCT Filed: Aug. 7, 2023
(86) PCT No.: PCT/US2023/029641

§ 371 Date: Feb. 5, 2025

Related U.S. Application Data
(60) Provisional application No. 63/370,700, filed on Aug. 8, 2022.

(51) Int. Cl. H04W 72/21

(52) U.S. Cl. CPC H04W 72/21

(57) ABSTRACT

A user equipment (UE configured to configure transceiver circuitry to transmit UE capability information related to uplink (UL) transmission (Tx) switching to a network, wherein the UE capability comprises an indication that the UE supports two or more supplementary uplink (SUL) bands or carriers, decode, from signaling received from the network, a UL Tx switching configuration based on at least the UE capability information, wherein the UL Tx switching configuration comprises one of 3 configured bands or 4 configured bands and perform UL transmissions based on the UL Tx switching configuration.

### PRIORITY/INCORPORATION BY REFERENCE

This application claims priority to U.S. Provisional Application Ser. No. 63/370,700 filed on Aug. 8, 2022 and entitled “Uplink Transmitter Switching with Multiple Supplementary Uplink Bands or Carriers,” the entirety of which is incorporated herein by reference.

### BACKGROUND

Supplementary uplink (SUL) was introduced in Rel-15 of the Fifth Generation (5G) New Radio (NR) standards. SUL extends the uplink coverage by providing a supplementary uplink (UL), typically in the sub-3 GHz band. SUL was introduced because typically cell coverage in the UL direction is not as good as in the DL direction. This may result from various factors such as the user equipment (UE) transmit power being lower than the transmit power of a base station. The performance usually becomes worse as the UE approaches a cell edge.

Currently, only a single SUL band with dynamic UL Tx switching is supported in the NR Rel-16/17 standards. It is contemplated that additional SUL bands will provide a better user experience and data throughput in the UL. However, adding additional SUL bands adds to the complexity of transmit switching. Thus, there needs to be mechanisms to handle multiple SUL band scenarios.

### SUMMARY

Some exemplary embodiments are related to an apparatus of a user equipment (UE), the apparatus having processing circuitry configured to configure transceiver circuitry to transmit UE capability information related to uplink (UL) transmission (Tx) switching to a network, wherein the UE capability comprises an indication that the UE supports two or more supplementary uplink (SUL) bands or carriers, decode, from signaling received from the network, a UL Tx switching configuration based on at least the UE capability information, wherein the UL Tx switching configuration comprises one of 3 configured bands or 4 configured bands and perform UL transmissions based on the UL Tx switching configuration.

Other exemplary embodiments are related to a processor configured to configure transceiver circuitry to transmit UE capability information related to uplink (UL) transmission (Tx) switching to a network, wherein the UE capability comprises an indication that the UE supports two or more supplementary uplink (SUL) bands or carriers, decode, from signaling received from the network, a UL Tx switching configuration based on at least the UE capability information, wherein the UL Tx switching configuration comprises one of 3 configured bands or 4 configured bands and perform UL transmissions based on the UL Tx switching configuration.

Still further exemplary embodiments are related to an apparatus of a base station, the apparatus having processing circuitry configured to decode, from signaling received from a user equipment (UE), UE capability information related to uplink (UL) transmission (Tx) switching, wherein the UE capability comprises an indication that the UE supports two or more supplementary uplink (SUL) bands or carriers, determine a UL Tx switching configuration based on at least the UE capability information, wherein the UL Tx switching configuration comprises one of 3 configured bands or 4 configured bands and configure transceiver circuitry to transmit the UL Tx switching configuration to the UE.

Additional exemplary embodiments are related to a processor configured to decode, from signaling received from a user equipment (UE), UE capability information related to uplink (UL) transmission (Tx) switching, wherein the UE capability comprises an indication that the UE supports two or more supplementary uplink (SUL) bands or carriers, determine a UL Tx switching configuration based on at least the UE capability information, wherein the UL Tx switching configuration comprises one of 3 configured bands or 4 configured bands and configure transceiver circuitry to transmit the UL Tx switching configuration to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary signaling diagram showing a UE being configured with an uplink (UL) transmission (Tx) switching configuration according to various exemplary embodiments.

FIG. 5 shows a table having multiple UL Tx switching configurations according to various exemplary embodiments.

### DETAILED DESCRIPTION

The exemplary embodiments may be further understood with reference to the following description and the related appended drawings, wherein like elements are provided with the same reference numerals. The exemplary embodiments relate to providing a user equipment (UE) with an uplink (UL) transmission (Tx) configuration where the UE supports multiple supplementary uplink (SUL) bands and/or carriers. The exemplary embodiments are described with reference to a UE and a network supporting 3 or 4 SULs.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G NR network that supports multiple SUL bands. However, it should be understood that the exemplary embodiments may be applied to any network that supports multiple SUL bands, including further evolutions of the cellular standards (e.g., 6G networks).

Furthermore, when describing the exemplary embodiments, multiple cells may be described. Those skilled in the art will understand that a 5G base station (e.g., gNB) may include multiple cells. In the examples, it will be considered that each of the described cells are related to the same base station. However, it should be understood that this is only for illustrative purposes, it is not a requirement of the exemplary embodiments that each cell be included in a single base station.

In addition, some exemplary embodiments are described with reference to a dual UL transmission mode. Those skilled in the art will understand that dual UL transmission mode indicates that the UE has more than one transmission chain that allows the UE to simultaneously transmit signals on different carriers.

As stated above, SUL was introduced in Rel-15 of the 5G NR standards. There were enhancements to SUL that were introduced in Rel-16 and Rel-17 as described below. For example, in Rel-16, two cases were specified for UL transmit (Tx) switching. In Case 1, there is 1Tx on carrier 1 and 1Tx on carrier 2. In Case 2, there is 0Tx on carrier 1 and 2Tx on carrier 2. In Rel-17, 2Tx chains can be configured and scheduled for either of the two configured carriers, unlike R16, where only one carrier (carrier 2) can be configured with 2Tx. In addition, another set of cases and corresponding switching were included to allow 1 carrier on one band and 2 contiguous carriers on another band (inter-band+intra-band). Furthermore, there were additional cases specified where the UE is not expected to be scheduled on the configured carriers with a UL transmission during the switching gap.

As can be seen from the above discussion, the number of SUL carriers remains limited through Rel-17. It is proposed that future releases support UL Tx switching schemes across up to 3 or 4 bands with a restriction of up to 2 Tx simultaneous transmissions for frequency range 1 (FR1) UEs, including mechanisms to enable more configured UL bands than its simultaneous transmission capability and to support dynamic Tx carrier switching across the configured bands for both a single timing advance group (TAG) and multiple TAGs configurations.

The exemplary embodiments propose solutions to support these multiple SUL scenarios. In some exemplary embodiments, when a UE is capable of supporting more than 2 UL bands and more than 1 UL contiguous carrier/band for dynamic UL TX switching, the UE may be configured with more than 1 SUL band and/or more than 1 contiguous SUL carriers per band, and the UE is not expected to be configured with a number of SUL carriers across all bands that is higher than the number of normal UL (NUL) carriers across all bands.

In other exemplary embodiments, when a UE is configured with dual UL mode for dynamic UL TX switching (e.g., when simultaneous transmission on 2 bands can be configured from a set of 3 or 4 bands), the UE may be configured with more than 1 SUL band, where the UE can be configured/indicated with simultaneous transmission on an SUL band and an NUL band, provided each of the bands corresponds to a different cell and/or the UE can be configured/indicated with simultaneous transmission on more than one SUL band, provided each of the bands corresponds to a different cell.

In still further exemplary embodiments, when a UE is capable of supporting more than 2 UL bands and more than 1 UL contiguous carrier/band for dynamic UL TX switching, the UE can report band combinations with M bands for dynamic UL Tx switching, where more than 1 band and/or carrier can be SUL and if the UE is further indicated with a sub-set of N bands from the set of M bands, then only 1 band out of N bands is expected to be SUL, while the other bands are NUL. The indication of a sub-set of N bands with the 1 SUL band/carrier may be signaled via Downlink Control Information (DCI) and/or a medium access control control element (MAC CE). Each of these exemplary embodiments will be described in greater detail below.

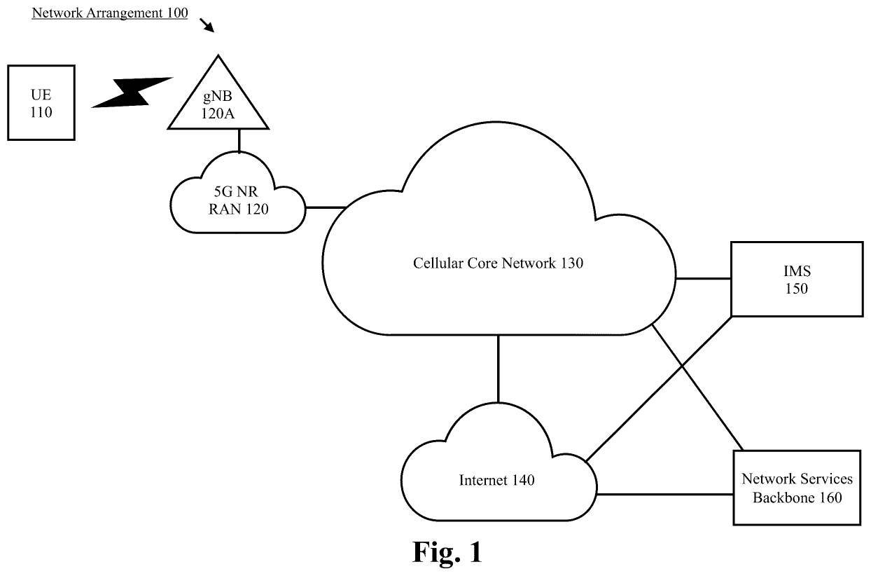

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

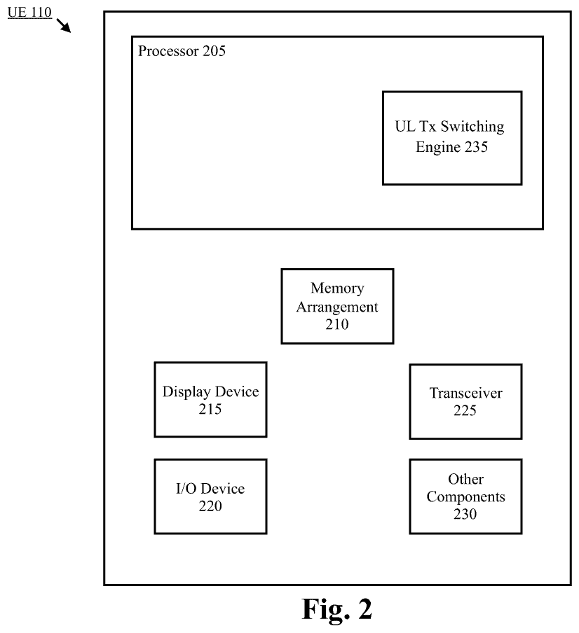

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a UL Tx switching engine 235. The UL Tx switching engine 235 may perform a variety of operations including reporting UE capabilities related to UL Tx switching to the network, receiving a UL Tx switching configuration from the network and implementing the UL Tx switching configuration. Each of these operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

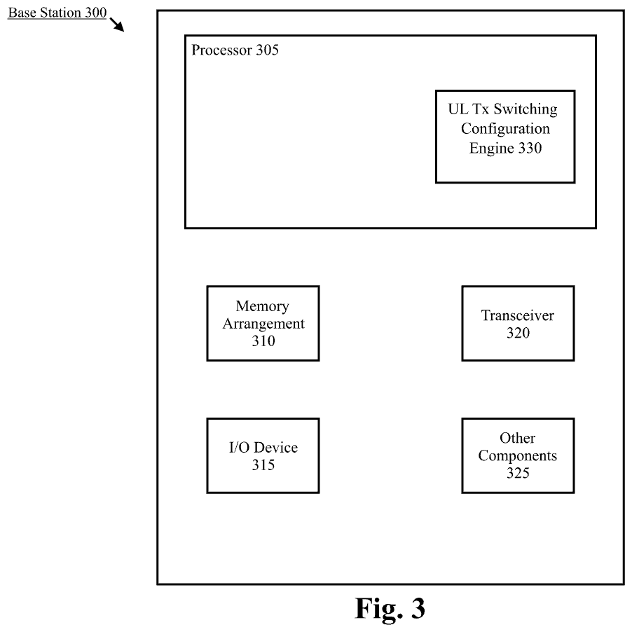

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a UL Tx switching configuration engine 330. The UL Tx switching configuration engine 330 may perform a variety of operations including receiving a report of UE capabilities related to UL Tx switching from the UE 110, determining a UL Tx switching configuration based on the UE capabilities, and sending the UL Tx switching configuration to the UE 110. Each of these operations will be described in greater detail below

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

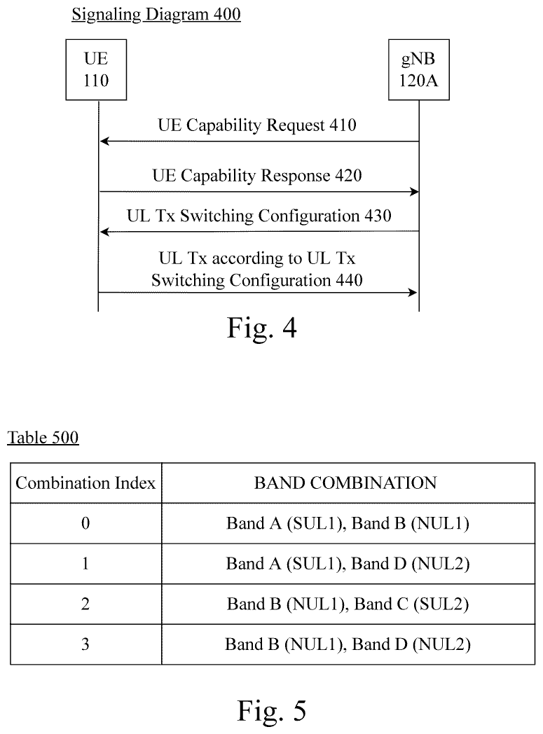

FIG. 4 shows an exemplary signaling diagram 400 showing a UE 110 being configured with a UL Tx switching configuration according to various exemplary embodiments. Prior to describing specific exemplary SUL configurations for the UE 110, signaling diagram 400 will show a general manner of configuring the UE 110.

In 410, the gNB 120A sends a UE capability request to the UE 110. Typically, the UE capability request may be sent during a registration procedure that the UE 110 is performing with the network. However, the network (via the gNB 120A) may request the UE capability information at any time including when the UE 110 is in a connected state (e.g., RRC Connected) with the network. In this example, the UE capability request will include a request for the UE capabilities related to UL Tx switching.

In 420, the UE 110 will respond to the UE capability request by sending the gNB 120A a UE capability response to inform the network of the UE capabilities. Those skilled in the art will understand that there may be multiple manners of signaling UE capabilities to the network. Any of these manners may be used to signal the capabilities of the UE 110. These capabilities may include the UE capabilities with respect to UL Tx switching, e.g., the number of SUL/NUL bands/carriers that are supported, the manner in which the SUL/NUL bands/carriers are supported, multiple band combinations for which the UE can support dynamic UL Tx switching, etc. Further examples of signaling the UE capability information are provided below.

The gNB 120A, after receiving the UE capability information in 420, may, in 430 configure or indicate to the UE 110 the specific UL Tx switching configuration that the UE 110 should use. As will be described in greater detail below, this UL Tx switching configuration may comprise information such as the bands/carriers for each of the SULs and/or NULs to be used by the UE 110 for UL transmissions. The UL Tx switching configuration provided in 430 may be sent in any type of message exchange between the gNB 120A and the UE 110, such as, in RRC, DCI, a MAC CE, etc.

In 440, the UE 110 performs the UL transmissions according to the UL Tx switching configuration provided in 430.

As described above, in some exemplary embodiments, when the UE 110 is capable of supporting more than 2 UL bands and more than 1 UL contiguous carrier/band for dynamic UL TX switching, the UE 110 may be configured with more than 1 SUL band and/or more than 1 contiguous SUL carriers per band, where the UE is not expected to be configured with a number of SUL carriers across all bands that is higher than the number of NUL carriers across all bands. These exemplary embodiments will be described by way of example below.

In a first example, it may be considered based on UE capability reporting that the UE 110 supports 3 bands for dynamic UL Tx switching. These bands will be referred to as Band A, Band B and Band C. A configuration rule or a UE capability may also indicate that the UE 110 can support a maximum of 2 contiguous SUL carriers within a band and only up to 1 band with up to 2 contiguous SUL carriers. This means the UE 110 may be configured/indicated either with a maximum of 2 SUL carriers across 2 bands or 2 SUL carriers within 1 band according to the following exemplary configurations that conform to the above described configuration rules and/or reported capability.

In a Case 3-1, Band A may have 2 SUL carriers, Band B may have 1 NUL carrier and Band C may have 1 NUL carrier. Thus, in this case, the UE 110 is configured with the maximum of 2 SUL carriers within 1 band, e.g., Band A. The UE 110 is also configured such that the number of SUL carriers across all bands (2), does not exceed the number of NUL carriers across all bands (2).

In a Case 3-2, Band A may have 1 SUL carrier, Band B may have 1 SUL carrier and Band C may have 2 NUL carriers. Thus, in this case, the UE 110 is configured with the maximum of 2 SUL carriers across 2 bands, e.g., Band A and Band B. Again, the UE 110 is also configured such that the number of SUL carriers across all bands (2), does not exceed the number of NUL carriers across all bands (2).

In a Case 3-3, Band A may have 1 SUL carrier and 1 NUL carrier, Band B may have 1 SUL carrier and Band C may have 1 NUL carrier. Thus, in this case, the UE 110 is configured with the maximum of 2 SUL carriers across 2 bands, e.g., Band A and Band B. The UE 110 is also configured such that the number of SUL carriers across all bands (2), does not exceed the number of NUL carriers across all bands (2).

In a Case 3-4, Band A may have 1 SUL carrier and 1 NUL carrier, Band B may have 1 NUL carrier and Band C may have 1 NUL carrier. Thus, in this case, the UE 110 is configured with less than the maximum of 2 SUL carriers across 2 bands, e.g., 1 SUL carrier in Band A. The UE 110 is also configured such that the number of SUL carriers across all bands (1), does not exceed the number of NUL carriers across all bands (3).

It should be understood that the above example and corresponding cases are not exhaustive. There may be other band/carrier combinations that also satisfy the configuration rules described above. The examples are provided to illustrate the manners which a UE may be configured to support multiple SULs.

In a second example, it may be considered based on the UE capability reporting that the UE 110 supports 4 bands for dynamic UL Tx switching. These bands will be referred to as Band A, Band B, Band C and Band D. Similar to the first example, can support a maximum of 2 contiguous SUL carriers within a band and only up to 1 band with up to 2 contiguous SUL carriers. This means the UE 110 may be configured/indicated either with a maximum of 2 SUL carriers across 2 bands or 2 SUL carriers within 1 band according to the following exemplary configurations that conform to the above described configuration rules and/or reported capability.

In a Case 4-1, Band A may have 1 SUL carrier, Band Bn may have 1 SUL carrier, Band C may have 1 NUL carrier and Band D may have 1 NUL carrier. Thus, in this case, the UE 110 is configured with the maximum of 2 SUL carriers across 2 bands, e.g., Band A and Band B. The UE 110 is also configured such that the number of SUL carriers across all bands (2), does not exceed the number of NUL carriers across all bands (2).

In a Case 4-2, Band A may have 2 SUL carriers, Band B may have 1 NUL carrier, Band C may have 1 NUL carrier and Band D may have 1 NUL carrier. Thus, in this case, the UE 110 is configured with the maximum of 2 SUL carriers within 1 band, e.g., Band A. The UE 110 is also configured such that the number of SUL carriers across all bands (2), does not exceed the number of NUL carriers across all bands (3).

In a Case 4-3, Band A may have 1 SUL carrier, Band B may have 1 SUL carrier, Band C may have 2 NUL carriers and Band D may have 1 NUL carrier. Thus, in this case, the UE 110 is configured with the maximum of 2 SUL carriers across 2 bands, e.g., Band A and Band B. The UE 110 is also configured such that the number of SUL carriers across all bands (2), does not exceed the number of NUL carriers across all bands (3).

In a Case 4-4, Band A may have 1 SUL carrier and 1 NUL carrier, Band B may have 1 SUL carrier, Band C may have 1 NUL carrier, and Band D may have 1 NUL carrier. Thus, in this case, the UE 110 is configured with the maximum of 2 SUL carriers across 2 bands, e.g., Band A and Band B. The UE 110 is also configured such that the number of SUL carriers across all bands (2), does not exceed the number of NUL carriers across all bands (3).

In a Case 4-5, Band A may have 1 SUL carrier and 1 NUL carrier, Band B may have 1 NUL carrier, Band C may have 1 NUL carrier and Band D may have 1 NUL carrier. Thus, in this case, the UE 110 is configured with less than the maximum of 2 SUL carriers across 2 bands, e.g., 1 SUL carrier in Band A. The UE 110 is also configured such that the number of SUL carriers across all bands (1), does not exceed the number of NUL carriers across all bands (4).

It should be understood that the above example and corresponding cases are not exhaustive. There may be other band/carrier combinations that also satisfy the configuration rules described above. The examples are provided to illustrate the manners which a UE may be configured to support multiple SULs.

In a third example, it may be considered based on UE capability reporting that the UE 110 supports 3 bands for dynamic UL Tx switching. These bands will be referred to as Band A, Band B and Band C. A configuration rule or UE capability may also indicate that the UE 110 can support a maximum of 2 contiguous SUL carriers within a band and more than 1 band with up to 2 contiguous SUL carriers. This means the UE 110 can be configured/indicated with either a maximum of 3 SUL carriers across 2 or 3 bands according to the following exemplary configurations that conform to the above described configuration rules and/or reported capability.

In a Case 3-1, Band A may have 2 SUL carriers, Band B may have 1 SUL carrier and 1 NUL carrier and Band C may have 2 NUL carriers. Thus, in this case, the UE 110 is configured with the maximum of 3 SUL carriers across 2 bands, e.g., Band A and Band B. The UE 110 is also configured such that the number of SUL carriers across all bands (3), does not exceed the number of NUL carriers across all bands (3).

In a Case 3-2, Band A may have 1 SUL carrier and 1 NUL carrier, Band B may have 1 SUL carrier and 1 NUL carrier, and Band C may have 1 SUL carrier and 1 NUL carrier. Thus, in this case, the UE 110 is configured with the maximum of 3 SUL carriers across 3 bands, e.g., Band A, Band B and Band C. The UE 110 is also configured such that the number of SUL carriers across all bands (3), does not exceed the number of NUL carriers across all bands (3).

It should be understood that the above example and corresponding cases are not exhaustive. There may be other band/carrier combinations that also satisfy the configuration rules described above. The examples are provided to illustrate the manners which a UE may be configured to support multiple SULs.

In a fourth example, it may be considered based on UE capability reporting that the UE 110 supports 4 bands for dynamic UL Tx switching. These bands will be referred to as Band A, Band B, Band C and Band D. A configuration rule or UE capability may also indicate that the UE 110 can support a maximum of 2 contiguous SUL carriers within a band and more than 1 band with up to 2 contiguous SUL carriers. This means the UE can be configured/indicated either with a maximum of 4 SUL carriers across 2, 3 or 4 bands, according to the following exemplary configurations that conform to the above described configuration rules and/or reported capability.

In a Case 4-1, Band A may have 2 SUL carriers, Band B may have 2 SUL carriers, Band C may have 2 NUL carriers, and Band D may have 2 NUL carriers. Thus, in this case, the UE 110 is configured with the maximum of 4 SUL carriers across 2 bands, e.g., Band A and Band B. The UE 110 is also configured such that the number of SUL carriers across all bands (4), does not exceed the number of NUL carriers across all bands (4).

In a Case 4-2, Band A may have 2 SUL carriers, Band B may have 1 SUL carrier, Band C may have 2 NUL carriers, and Band D may have 1 NUL carrier. Thus, in this case, the UE 110 is configured with less than the maximum of 4 SUL carriers, e.g., 2 SUL carriers in Band A and 1 SUL carrier in Band B. The UE 110 is also configured such that the number of SUL carriers across all bands (3), does not exceed the number of NUL carriers across all bands (3).

In a Case 4-3, Band A may have 1 SUL carrier and 1 NUL carrier, Band B may have 1 SUL carrier and 1 NUL carrier, Band C may have 1 SUL carrier and 1 NUL carrier, and Band D may have 1 SUL carrier and 1 NUL carrier. Thus, in this case, the UE 110 is configured with the maximum of 4 SUL carriers across 4 bands, e.g., each of Band A through Band D has one SUL carrier. The UE 110 is also configured such that the number of SUL carriers across all bands (4), does not exceed the number of NUL carriers across all bands (4).

It should be understood that the above example and corresponding cases are not exhaustive. There may be other band/carrier combinations that also satisfy the configuration rules described above. The examples are provided to illustrate the manners which a UE may be configured to support multiple SULs.

Thus, the above examples illustrate the exemplary embodiments where the UE 110 is capable of supporting more than 2 UL bands and more than 1 UL contiguous carrier/band for dynamic UL TX switching and where the where the UE is not expected to be configured with a number of SUL carriers across all bands that is higher than the number of NUL carriers across all bands.

As described above, in other exemplary embodiments, when the UE 110 is configured with dual UL mode for dynamic UL Tx switching (e.g., the UE 110 is capable of simultaneous transmission on 2 bands that can be configured from a set of 3 or 4 bands), the UE 110 may be configured with more than 1 SUL band. In such cases, the UE 110 can be configured/indicated with simultaneous transmission on an SUL band and an NUL band, provided each of the bands corresponds to different cell. The UE 110 may also be configured/indicated with simultaneous transmission on more than one SUL band, provided each of the bands corresponds to different cell.

For example, in one option, one UL Tx may be indicated on a SUL band with 1 or more contiguous carriers and another (simultaneous) UL Tx may be indicated on an NUL band with 1 or more contiguous carriers. As described above, the indicated SUL band/carriers does not correspond to the indicated NUL band/carriers on the same serving cell. To provide an example, it may be considered that the UE 110 may be indicated/configured with 2 contiguous SUL carriers on Band A and 2 contiguous NUL carriers on Band B for simultaneous transmissions with the consideration that the Band A carriers and Band B carriers are not on the same serving cell.

In another option, one UL Tx may be indicated/configured on an SUL band with 1 or more contiguous carriers and another (simultaneous) UL Tx may be indicated on another SUL band with 1 carrier. To provide an example, it may be considered that the UE 110 may be indicated/configured with 2 contiguous SUL carriers on Band A and 1 SUL carrier on Band B for simultaneous transmissions with the consideration that the Band A carriers and Band B carriers are not on the same serving cell.

In these exemplary embodiments, other combinations for simultaneous UL transmission on 2 TX chains is not expected to be indicated to UE for dynamic UL Tx switching involving more than 1 SUL band/carrier.

As described above, in further exemplary embodiments, when the UE 110 is capable of supporting more than 2 UL bands and more than 1 UL contiguous carrier/band for dynamic UL TX switching, the UE 110 may be configured with M bands for dynamic UL Tx switching, where more than 1 band and/or carrier can be an SUL. The UE 110 may be further indicated with a sub-set of N bands from the set of M bands, where only 1 band out of the N bands is expected to be an SUL, while the other bands are NUL.

For example, in one option, it may be considered that M=3 and N=2, then among the M=3 configured bands, 1 or 2 bands of 3 configured bands can be SUL, but among the indicated N=2 bands, only 1 of the indicated bands can be SUL and the other indicated band is NUL and only the NUL may have 1 or 2 contiguous carriers, while the indicated SUL band can have only 1 contiguous carrier.

To provide an example of such a scenario, again, it may be considered that if M=3 and N=2 and that the bands are Band A, Band B and Band C, where Band A and Band B are the subset N=2. Using the configuration rules described above, Band A may have 1 SUL carrier, Band B may have 2 contiguous NUL carriers and Band C may have 1 SUL carrier. Thus, in this example, there are multiple SUL bands in the set M=3, e.g., Band A and Band C. In addition, there is only 1 SUL band in the subset N=2 and only 1 carrier in that band, e.g., Band A, and the Band B has 2 contiguous carriers. Multiple combinations for N=2 bands (out of M=3 bands) can also be configured and from which a single combination can be indicated to the UE 110.

In another option, it may be considered that M=4 and N=3, then among the M=4 configured bands, 1 or 2 bands out of 4 configured bands can be SUL, and among the indicated N=3 bands, either 1 band can be SUL with 1 or 2 contiguous carriers and the other 2 bands are NUL or 2 bands can be SUL with 1 carrier each and the other band is NUL with 2 contiguous carriers.

To provide a first example of such a scenario, it may be considered that if M=4 and N=3 and that the bands are Band A, Band B, Band C, and Band D where Band A, Band B and Band C are the subset N=3. Using the configuration rules described above, Band A may have 1 SUL carrier, Band B may have 1 SUL carrier, Band C may have 2 NUL carriers and Band D may have 1 NUL carrier. Thus, in this example, there are 2 SUL bands in the set M=4 and 2 SUL bands in the subset N=3, e.g., Band A and Band B. In addition, there is only 1 carrier per SUL band and 2 carriers in the NUL band in the subset N=3, e.g., Band C has two contiguous NUL carriers. Multiple combinations for N=3 bands (out of M=4 bands) can also be configured and from which a single combination can be indicated to the UE 110.

To provide a second example of such a scenario, it may be considered that if M=4 and N=3 and that the bands are Band A, Band B, Band C, and Band D where Band A, Band B and Band C are the subset N=3. Using the configuration rules described above, Band A may have 2 SUL carriers, Band B may have 1 NUL carrier, Band C may have one NUL carrier and Band D may have 1 NUL carrier. Thus, in this example, there is one SUL band in the set M=4 and the subset N=3, e.g., Band A. In addition, because Band A in the subset N=3 includes two contiguous SUL carriers, the other two bands in the subset N=3 are NUL bands, e.g., Band B and Band C.

It should be understood that the above examples for both options are not exhaustive. There may be other band/carrier combinations that also satisfy the configuration rules described above. The examples are provided to illustrate the manners which a UE may be configured to support multiple SULs.

As described above with reference to the signaling diagram 400 of FIG. 4, the UE 110 may report capability information related to UL Tx switching. For example, in some embodiments, the UE 110 may indicate support for more than 1 SUL band and/or carrier for dynamic UL Tx switching. In other examples, the UE 110 may indicate which mode of configuration the UE 110 supports when more than 2 bands can be configured for dynamic UL Tx switching. For example, the UE 110 may report support for a first mode where all of the 3 or 4 bands may be configured for dynamic UL Tx switching. In another example, the UE 110 may report support for a second mode where 3 or 4 bands may be configured for UL TX switching, but only a subset of 2 or 3 bands may be indicated to the UE 110 for participating in dynamic UL Tx switching at any given time. The UE 110 may indicate support for both modes, which then allows the network to configure the UE 110 with any of the supported modes.

FIG. 5 shows a table 500 having multiple UL Tx switching configurations according to various exemplary embodiments. The table 500 may be used with reference to the exemplary embodiments described above related to the set of M bands and the subset of N bands. In this example, the UE 110 may be semi-statically configured with a new radio resource control (RRC) information element (IE) or a new parameter in an existing IE, that is used to configure the UE 110 with the table 500.

As shown in FIG. 5, the table 500 has multiple rows and each row indicates 2 UL bands. The combination of 2 UL bands is selected from the 3 or 4 band combination reported by the UE 110 and only up to 1 of the 2 UL bands is an SUL. Each row also includes a combination index.

In some exemplary embodiments, the UE 110 may be dynamically indicated by DCI format such as format 0_1 (for UL grant) or a MAC CE command to indicate the index of the configured table, where a new bitfield may be added to the format. The number of bits may depend on the size of the table, which can depend on the set of band combinations. In the example of FIG. 5, 2 bits can be used.

In other exemplary embodiments, the UE 110 is dynamically indicated by DCI format such as format 0_1 to indicate the index of the configured table with an existing bitfield such as the carrier indicator field or the UL/SUL indicator field or a MAC CE command. If the UE 110 is configured with the table for dynamic UL Tx switching as described above, then the existing field(s) can be reinterpreted to indicate the index of the above table, otherwise, the same interpretation as currently specified may be used.

### EXAMPLES

In a first example, a method is performed by a user equipment (UE), comprising reporting UE capability information related to uplink (UL) transmission (Tx) switching to a network, wherein the UE capability comprises an indication that the UE Supports two or more supplementary uplink (SUL) bands or carriers, receiving, from the network, a UL Tx switching configuration based on at least the UE capability information and performing UL transmissions based on the UL Tx switching configuration.

In a second example, the method of the first example, wherein the UL Tx switching configuration comprises one of 3 configured bands or 4 configured bands.

In a third example, the method of the second example, wherein the UL Tx switching configuration comprises a first number of SUL carriers across all configured bands that is less than or equal to a second number of normal uplink (NUL) carriers across all configured bands.

In a fourth example, the method of the third example, wherein the UL Tx switching configuration further comprises a maximum of 2 SUL carriers across 2 configured bands or 2 SUL carriers within 1 band.

In a fifth example, the method of the third example, wherein, when the UL Tx switching configuration comprises 3 configured bands, the UL Tx switching configuration further comprises a maximum of 3 SUL carriers across 2 or 3 configured bands.

In a sixth example, the method of the fifth example, wherein the maximum of 3 SUL carriers comprises 2 SUL carriers within 1 band.

In a seventh example, the method of the third example, wherein, when the UL Tx switching configuration comprises 4 configured bands, the UL Tx switching configuration further comprises a maximum of 4 SUL carriers across 2, 3 or 4 bands.

In an eighth example, the method of the fifth example, wherein the maximum of 4 SUL carriers comprises 2 SUL carriers within 1 band.

In a ninth example, the method of the first example, wherein the UE capability information indicates one of a first mode where the UE supports UL Tx switching for the 3 configured bands or the 4 configured bands, a second mode where the UE supports Tx switching for the 3 configured bands but only a subset of 2 of the 3 configured bands at a given time, and a third mode where the UE supports Tx switching for the 4 configured bands but only a subset of 2 or 3 of the 4 configured bands at a given time.

In a tenth example, the method of the ninth example, wherein the UE capability information comprises support for the first mode, the second mode, the third mode or any combination thereof.

In an eleventh example, the method of the ninth example, wherein the UL Tx switching configuration corresponding to the second mode comprises 1 or 2 SUL bands of the 3 configured bands and the subset of 2 bands comprises 1 SUL band and 1 NUL band.

In a twelfth example, the method of the eleventh example, wherein the 1 NUL band of the subset of 2 bands comprises 1 or 2 contiguous carriers and the 1 SUL band of the subset of 2 bands comprises only 1 carrier.

In a thirteenth example, the method of the ninth example, wherein the UL Tx switching configuration corresponding to the third mode comprises 1 or 2 SUL bands of the 4 configured bands and the subset of 3 bands comprises 1 SUL band with 1 or 2 contiguous carriers and 2 NUL bands.

In a fourteenth example, the method of the ninth example, wherein the UL Tx switching configuration corresponding to the third mode comprises 1 or 2 SUL bands of the 4 configured bands and the subset of 3 bands comprises 2 SUL bands with 1 carrier each and 1 NUL band with 2 contiguous carriers.

In a fifteenth example, the method of the ninth example, wherein the UE includes a table listing band combinations and the UL Tx switching configuration comprises an indication of an entry in the table.

In a sixteenth example, the method of the first example, wherein the UL Tx switching configuration is received in one of Downlink Control Information (DCI), a medium access control control element (MAC CE) or radio resource control (RRC) signaling.

In a seventeenth example, a processor configured to perform any of the methods of the first through sixteenth examples.

In an eighteenth example, a user equipment (UE) comprising a transceiver configured to communicate with a network and a processor communicatively coupled to the transceiver and configured to perform any of the methods of the first through sixteenth examples.

In a nineteenth example, a method is performed by a base station, comprising receiving, from a user equipment (UE), UE capability information related to uplink (UL) transmission (Tx) switching, wherein the UE capability comprises an indication that the UE supports two or more supplementary uplink (SUL) bands or carriers, determining a UL Tx switching configuration based on at least the UE capability information and transmitting the UL Tx switching configuration to the UE.

In a twentieth example, the method of the nineteenth example, wherein the UL Tx switching configuration comprises one of 3 configured bands or 4 configured bands.

In a twenty first example, the method of the twentieth example, wherein a first number of SUL carriers across all configured bands that is less than or equal to a second number of normal uplink (NUL) carriers across all configured bands.

In a twenty second example, the method of the twenty first example, wherein the UL Tx switching configuration further comprises a maximum of 2 SUL carriers across 2 configured bands or 2 SUL carriers within 1 band.

In a twenty third example, the method of the twenty first example, wherein, when the UL Tx switching configuration comprises 3 configured bands, the UL Tx switching configuration further comprises a maximum of 3 SUL carriers across 2 or 3 configured bands.

In a twenty fourth example, the method of the twenty third example, wherein the maximum of 3 SUL carriers comprises 2 SUL carriers within 1 band.

In a twenty fifth example, the method of the twenty first example, wherein, when the UL Tx switching configuration comprises 4 configured bands, the UL Tx switching configuration further comprises a maximum of 4 SUL carriers across 2, 3 or 4 bands.

In a twenty sixth example, the method of the twenty third example, wherein the maximum of 4 SUL carriers comprises 2 SUL carriers within 1 band.

In a twenty seventh example, the method of the twentieth example, wherein the UE capability information indicates one of a first mode where the UE supports UL Tx switching for the 3 configured bands or the 4 configured bands, a second mode where the UE supports Tx switching for the 3 configured bands but only a subset of 2 of the 3 configured bands at a given time, and a third mode where the UE supports Tx switching for the 4 configured bands but only a subset of 2 or 3 of the 4 configured bands at a given time.

In a twenty eighth example, the method of the twenty seventh example, wherein the UE capability information comprises support for the first mode, the second mode, the third mode or any combination thereof.

In a twenty ninth example, the method of the twenty seventh example, wherein the UL Tx switching configuration corresponding to the second mode comprises 1 or 2 SUL bands of the 3 configured bands and the subset of 2 bands comprises 1 SUL band and 1 NUL band.

In a thirtieth example, the method of the twenty ninth example, wherein the 1 NUL band of the subset of 2 bands comprises 1 or 2 contiguous carriers and the 1 SUL band of the subset of 2 bands comprises only 1 carrier.

In a thirty first example, the method of the twenty seventh example, wherein the UL Tx switching configuration corresponding to the third mode comprises 1 or 2 SUL bands of the 4 configured bands and the subset of 3 bands comprises 1 SUL band with 1 or 2 contiguous carriers and 2 NUL bands.

In a thirty second example, the method of the twenty Seventh example, wherein the UL Tx switching configuration corresponding to the third mode comprises 1 or 2 SUL bands of the 4 configured bands and the subset of 3 bands comprises 2 SUL bands with 1 carrier each and 1 NUL band with 2 contiguous carriers.

In a thirty third example, the method of the twenty seventh example, wherein the UL Tx switching configuration comprises an indication of an entry in a table listing band combinations stored in the UE.

In a thirty fourth example, the method of the nineteenth example, wherein the UL Tx switching configuration is transmitted in one of Downlink Control Information (DCI), a medium access control control element (MAC CE) or radio resource control (RRC) signaling.

In a thirty fifth example, a processor configured to perform any of the methods of the nineteenth through thirty fourth examples.

In an thirty sixth example, a base station comprising a transceiver configured to communicate with a user equipment (UE) and a processor communicatively coupled to the transceiver and configured to perform any of the methods of the nineteenth through thirty fourth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
configure transceiver circuitry to transmit UE capability information related to uplink (UL) transmission (Tx) switching to a network, wherein the UE capability comprises an indication that the UE supports two or more supplementary uplink (SUL) bands or carriers;
decode, from signaling received from the network, a UL Tx switching configuration based on at least the UE capability information, wherein the UL Tx switching configuration comprises one of 3 configured bands or 4 configured bands; and
perform UL transmissions based on the UL Tx switching configuration.

2. The apparatus of claim 1, wherein the UL Tx switching configuration comprises a first number of SUL carriers across all configured bands that is less than or equal to a second number of normal uplink (NUL) carriers across all configured bands.

3. The apparatus of claim 1, wherein the UE capability information indicates one of a first mode where the UE supports UL Tx switching for the 3 configured bands or the 4 configured bands, a second mode where the UE supports Tx switching for the 3 configured bands but only a subset of 2 of the 3 configured bands at a given time, and a third mode where the UE supports Tx switching for the 4 configured bands but only a subset of 2 or 3 of the 4 configured bands at a given time.

4. The apparatus of claim 3, wherein the UL Tx switching configuration corresponding to the second mode comprises 1 or 2 SUL bands of the 3 configured bands and the subset of 2 bands comprises 1 SUL band and 1 NUL band.

5. The apparatus of claim 4, wherein the 1 NUL band of the subset of 2 bands comprises 1 or 2 contiguous carriers and the 1 SUL band of the subset of 2 bands comprises only 1 carrier.

6. The apparatus of claim 3, wherein the UL Tx switching configuration corresponding to the third mode comprises 1 or 2 SUL bands of the 4 configured bands and the subset of 3 bands comprises 1 SUL band with 1 or 2 contiguous carriers and 2 NUL bands.

7. The apparatus of claim 3, wherein the UL Tx switching configuration corresponding to the third mode comprises 1 or 2 SUL bands of the 4 configured bands and the subset of 3 bands comprises 2 SUL bands with 1 carrier each and 1 NUL band with 2 contiguous carriers.

8. A processor configured to:
configure transceiver circuitry to transmit UE capability information related to uplink (UL) transmission (Tx) switching to a network, wherein the UE capability comprises an indication that the UE supports two or more supplementary uplink (SUL) bands or carriers;
decode, from signaling received from the network, a UL Tx switching configuration based on at least the UE capability information, wherein the UL Tx switching configuration comprises one of 3 configured bands or 4 configured bands; and
perform UL transmissions based on the UL Tx switching configuration.

9. The processor of claim 8, wherein the UL Tx switching configuration comprises a first number of SUL carriers across all configured bands that is less than or equal to a second number of normal uplink (NUL) carriers across all configured bands.

10. The processor of claim 8, wherein the UE capability information indicates one of a first mode where the UE supports UL Tx switching for the 3 configured bands or the 4 configured bands, a second mode where the UE supports Tx switching for the 3 configured bands but only a subset of 2 of the 3 configured bands at a given time, and a third mode where the UE supports Tx switching for the 4 configured bands but only a subset of 2 or 3 of the 4 configured bands at a given time.

11. The processor of claim 10, wherein the UL Tx switching configuration corresponding to the second mode comprises 1 or 2 SUL bands of the 3 configured bands and the subset of 2 bands comprises 1 SUL band and 1 NUL band.

12. The processor of claim 10, wherein the UL Tx switching configuration corresponding to the third mode comprises 1 or 2 SUL bands of the 4 configured bands and the subset of 3 bands comprises 1 SUL band with 1 or 2 contiguous carriers and 2 NUL bands.

13. The processor of claim 10, wherein the UL Tx switching configuration corresponding to the third mode comprises 1 or 2 SUL bands of the 4 configured bands and the subset of 3 bands comprises 2 SUL bands with 1 carrier each and 1 NUL band with 2 contiguous carriers.

14. An apparatus of a base station, the apparatus comprising processing circuitry configured to:
decode, from signaling received from a user equipment (UE), UE capability information related to uplink (UL) transmission (Tx) switching, wherein the UE capability comprises an indication that the UE supports two or more supplementary uplink (SUL) bands or carriers;
determine a UL Tx switching configuration based on at least the UE capability information, wherein the UL Tx switching configuration comprises one of 3 configured bands or 4 configured bands; and
configure transceiver circuitry to transmit the UL Tx switching configuration to the UE.

15. The apparatus of claim 14, wherein the UL Tx switching configuration comprises a first number of SUL carriers across all configured bands that is less than or equal to a second number of normal uplink (NUL) carriers across all configured bands.

16. The apparatus of claim 14, wherein the UE capability information indicates one of a first mode where the UE supports UL Tx switching for the 3 configured bands or the 4 configured bands, a second mode where the UE supports Tx switching for the 3 configured bands but only a subset of 2 of the 3 configured bands at a given time, and a third mode where the UE supports Tx switching for the 4 configured bands but only a subset of 2 or 3 of the 4 configured bands at a given time.

17. The apparatus of claim 16, wherein the UL Tx switching configuration corresponding to the second mode comprises 1 or 2 SUL bands of the 3 configured bands and the subset of 2 bands comprises 1 SUL band and 1 NUL band.

18. The apparatus of claim 17, wherein the 1 NUL band of the subset of 2 bands comprises 1 or 2 contiguous carriers and the 1 SUL band of the subset of 2 bands comprises only 1 carrier.

19. The apparatus of claim 16, wherein the UL Tx switching configuration corresponding to the third mode comprises 1 or 2 SUL bands of the 4 configured bands and the subset of 3 bands comprises 1 SUL band with 1 or 2 contiguous carriers and 2 NUL bands.

20. The apparatus of claim 16, wherein the UL Tx switching configuration corresponding to the third mode comprises 1 or 2 SUL bands of the 4 configured bands and the subset of 3 bands comprises 2 SUL bands with 1 carrier each and 1 NUL band with 2 contiguous carriers.
